(19) United States
(12) Patent Application Publication
(10) Pub. No.: US 2014/0077430 A1
(43) Pub. Date: Mar. 20, 2014

(54) BUMPER STOPPER FOR A SHOCK ABSORBER

(71) Applicants: Yong-Hoon HEO, Daegu (KR); Young-Chun KIM, Daegu (KR)

(72) Inventors: Yong-Hoon HEO, Daegu (KR); Young-Chun KIM, Daegu (KR)

(21) Appl. No.: 13/618,031

(22) Filed: Sep. 14, 2012

(51) Int. Cl. B60G 11/22

(52) U.S. Cl. 267/292

(57) ABSTRACT

A shock absorber for a bump stopper includes a plurality of corrugated projection 12 and corrugated groove 13 which is formed in equal interval around outside of an elastic synthetic resin body 11 having a thickness of 1.5 mm˜5 mm; a locking member 14 formed to mount the shock absorber on the top of the body 11; a through hole 15 formed inside the locking member 14; a leading hole 17 formed to lead cylinder lot L in the central part of a shock absorbing plate 16 forming the lower side of the body 11; a wedge hanging projection 14a formed in the locking member 14 of the body; and an O-ring shock absorbing member T to ease the impact applied to a bent part R in contraction of a body 11, in a “<” or “>”-type bent part R.

### TECHNICAL FIELD

The present invention relates to a bumper stopper for a shock absorber. More particularly, the present invention is a shock absorber used as a vehicle shock absorber and is to provide a bumper stopper which is used to deal with impact of cylinder ascending/descending according to the running state of a vehicle.

### BACKGROUND ART

In vehicle, yawing, vibration, and impact according to the curve and slope of road, acceleration and brake, turn, etc pass from various direction, and a shock absorber is used as means to control a vehicle stable in such vibration or yawing.

The shock absorber is embodied by a combination of cylinder which fills oil or gas and a coil-type spring which covers the cylinder, and a bumper stopper which deals with impact of cylinder and a dust cover which protects the cylinder from dust or other impurities are comprised in components of shock absorber.

An example of a related bumper stopper 1 is illustrated in FIG. 1 and cross sectional view of the related bumper stopper 1 is illustrated in FIG. 2. As illustrated, the related bumper stopper 1 includes a plurality of corrugated groove 1b formed in a body 1a manufactured to form inverse taper shape by urethane foam material, a insertion hole 1c which penetrated a body 1a perpendicularly in the central part of a body 1a, and combination means 1d which projects upper to the upper side of a insertion hole 1c.

An example of the related dust cover 2 is illustrated in FIG. 3. As illustrated, the dust cover 2 includes a stepped portion 2b for locking in upper side of a cylindrical body of pipe which has open lower part and closed upper part, and a locking hole 2c formed in inner side of stepped portion 2b for locking.

In FIG. 4, An embodiment of shock absorber applied with related bumper stopper 1 and dust cover 2 is illustrated. As illustrated, coil-type spring S is installed between a spring retainer 5 installed in the bottom of a mount bracket 4 and a spring seat 6 installed to maintain regular distance, and a cylinder C which passes through the inside of coil-type spring S is installed, and a stepped portion 2b is inserted in the bottom side of spring retainer 5 and mount a dust cover 2 to embody the shock absorber 3, a bumper stopper 1 is mounted separately inner upper side of dust cover 2 using combination means 1d to fix an end part of lot L by penetrating lot of cylinder with insertion hole 1c of the bumper stopper 1, and the bumper stopper 1 and the dust cover 2 are manufactured separately to be mounted on the shock absorber 3 by separate process.

A bumper stopper used in the related shock absorber is manufactured with urethane foam material and as the entire quantity is discarded since it is not recyclable after use and also it has expensive manufacturing cost due to the expensive materials, the problem that it is very unreasonable in cost and environmental aspect is constantly raised. Also as a dust cover used in the related shock absorber is manufactured separately and is mounted on the shock absorber, the problem, which it not only works as a factor that complicates the manufacturing process of the shock absorber but also works as a factor of cost increase, is pointed out.

### DISCLOSURE

### Technical Problem

Therefore, the present disclosure has been made in view of the above mentioned problems to provide in one aspect a bumper stopper to solve all problems of the bumper stopper and the dust cover, and is completed placing emphasis of technical problem on minimizing environmental load by reducing manufacturing cost by providing a bumper stopper which can do projection molding with recyclable synthetic resin(PP,PE) and also by enabling recycle after use.

The other purpose of the present invention is to solve is to unify the bumper stopper and the dust cover to reduce the manufacturing cost of shock absorber, and also to simplify the production process of the shock absorber and provide a bumper stopper which can increase production efficiency.

The additional purpose of the present invention is to minimize the contact impact in contraction due to the collision with cylinder which ascends and descends to enhance shock absorber efficiency and durability and to provide a bumper stopper which can minimize the noise generated in contraction due to the collision with the cylinder.

### Technical Solution

An aspect of the present disclosure provides an A shock absorber for a bump stopper comprises a plurality of corrugated projection 12 and corrugated groove 13, forming hollow wrinkle pipe, which is formed in equal interval around outside of an elastic synthetic resin body 11 having a thickness of 1.5 mm˜5 mm; a locking member 14 formed to mount the shock absorber on the top of the body 11; a through hole 15 formed inside the locking member 14; a leading hole 17 formed to lead cylinder lot L in the central part of a shock absorbing plate 16 forming the lower side of the body 11; a wedge hanging projection 14a formed in the locking member 14 of the body 11 to be hanged on the stepped portion part 5a of a spring retainer 5; and an O-ring shock absorbing member T, which is manufactured with soft synthetic resins, to ease the impact applied to a bent part R in contraction of a body 11, in a “<” or “>”-type bent part R which forms in the boundary of inside and outside of the corrugated projection 12 and the corrugated groove 13 of the body 11.

Another aspect of the present disclosure provides an A shock absorber for a bump stopper comprises a plurality of corrugated projection 12 and corrugated groove 13, forming hollow wrinkle pipe, which form in equal interval around outside of an elastic synthetic resin body having a thickness of 1.5 mm˜5 mm; a locking member 14, a wedge hanging projection 14a, and a through hole 15 formed to mount a shock absorber on the upper side of a body 11; a leading hole 17 which can lead cylinder lot L in the bottom of the body 11; a dust cover 20 arranged in a shock absorbing plate 16 prepared in a leading hole 17 to unify the body 11, the shock absorbing plate 16, and the dust cover 20; a plurality of corrugated projection 22 and corrugated groove 23 which form in equal interval around outer circumferential surface of the dust cover 20; a banding part 24 having diameter which is reduced compared to the dust cover 20 in the upper side of the leading opening 21 so that inner side of the bending part 24 can be compressed on the outer circumferential surface of a cylinder C; and an O-ring shock absorbing member T, which is manufactured with soft synthetic resins, to ease the impact applied to a bent part R in contraction of a body 11, in a “<” or “>”-type bent part R which forms in the boundary of inside and outside of the corrugated projection 12 and the corrugated groove 13 of the body 11, wherein the wedge form hanger projection 14a is placed in the locking member 14 of the body 11 to hang in a stepped portion part 5a of a spring retainer 5.

### Advantageous Effects

Accordingly, a bumper stopper presented in the present invention enables mass production with low cost due to the injection molding using synthetic resins, and has advantage of minimizing environmental load since it not only reduces manufacturing cost of shock absorber but also enables recycle of entire quantity after use of bumper stopper. Also, a bumper stopper presented in the present invention provides a dust cover in all-in-one and reduces cost and the number of component and process and increases the productivity of the shock absorber.

And, the present invention has effect of enhancing durability of bumper stopper by minimizing impact generated in bent part where shock absorbing member absorbs shock even though there is contact of bent part in contraction due to the collision with a cylinder ascending/descending according to the running state of a vehicle, and also of minimizing the generation of noise according to the contraction of the bent part.

### DESCRIPTION OF DRAWINGS

FIGS. 1a and 1b are a front view and a sectional view illustrating an example of the related.

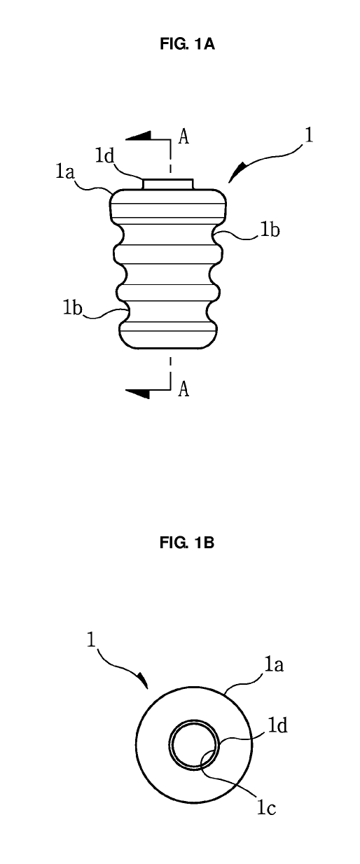

FIG. 2 is A-A line cross-sectional view marked in FIG. 1a.

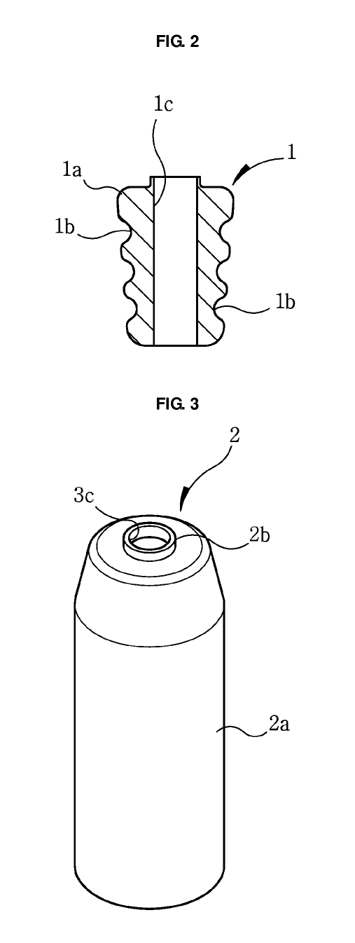

FIG. 3 is a perspective view illustrating an example of the related dust cover.

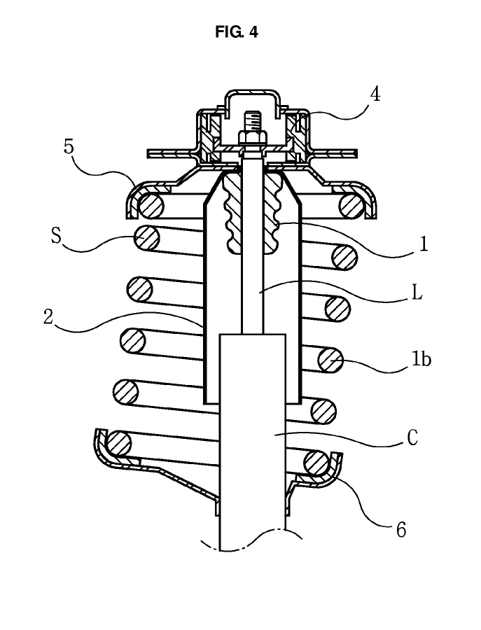

FIG. 4 is a reference cross-sectional view of shock absorber which is applied with the related bumper stopper and dust cover.

FIGS. 5a and 5b are a front view and a sectional view of bumper stopper presented in the present invention.

FIG. 6 is a B-B line cross-sectional view marked in FIG. 5a.

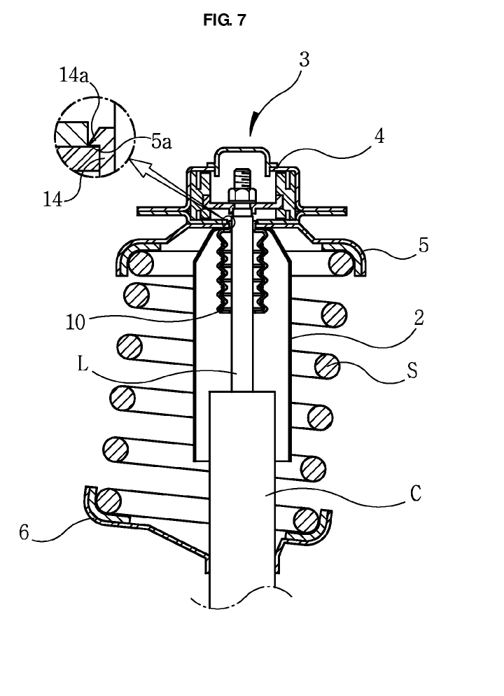

FIG. 7 is a view illustrating usage constitution of the present invention.

FIGS. 8a and 8b are a front view and a sectional view of other embodiment of the present invention.

FIG. 9 is a D-D line cross-sectional view made in FIG. 8a.

FIG. 10 is a view illustrating usage constitution of other embodiment of the present invention.

FIGS. 11a-11f are reference views illustrating another embodiment of a shock absorbing member according to the present invention.

### MODE FOR INVENTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

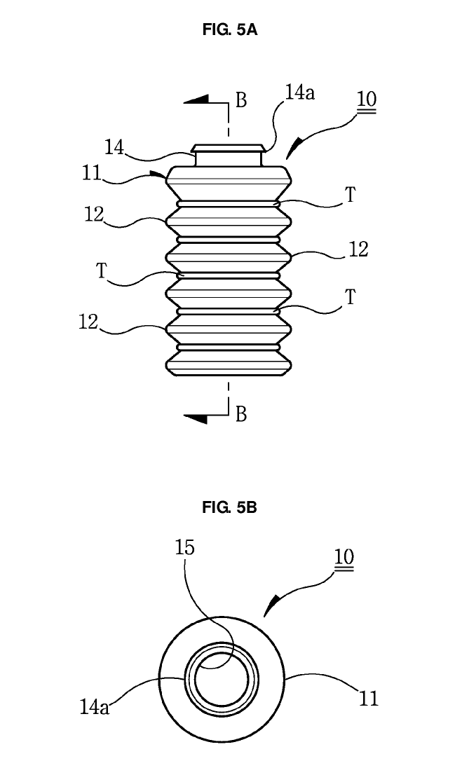

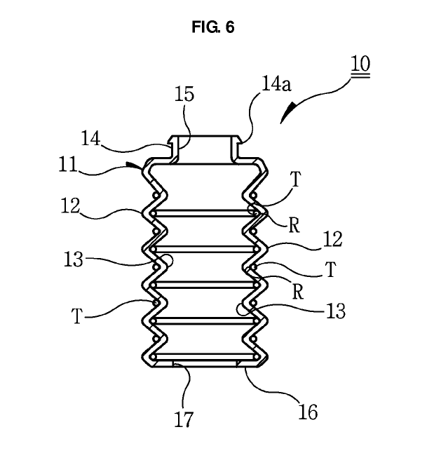

Advisable embodiment of a bumper stopper 10 presented in the present invention is illustrated in FIG. 4 [A],[B]and a cross-sectional view which cut a bumper stopper lengthwise is illustrated in FIG. 5. As illustrated, the present invention a molded body 11 to have a thickness of 1.5 mm˜5 mm with elastic synthetic resin such as PP, PE, etc, prepares a plurality of corrugated projection 12 and corrugated groove 13 which are formed continuously at regular interval around outer circumferential surface of a body 11, and molds a body to form hollow wrinkle pipe shape and give a body 11 elasticity shock absorbing power such as spring through the combination of corrugated projection 12 and corrugated groove 13.

A locking member 14 for mounting a shock absorber on the top of the body 11 is formed in a body, a through hole 15 in which a cylinder lot passes through is bored inside a locking member 14, the lower side of the body 11 is closed so that closed lower side can function as a shock absorbing plate 16, and a leading hole 17 in which cylinder lot can be lead is formed in the central part of the shock absorbing plate 16. A plurality of “<” or “>” type bent part R is formed inside and outside of the boundary of corrugated projection 12 and corrugated groove 13 by forming corrugated projection 12 and corrugated groove 13 in a body 11, and O-ring shock absorbing material T, which is manufactured with soft synthetic resins, is interposed in each bent parts R to absorb shock applied to the bent part R in contraction of the body 11 and also to minimize the noise according to the impact.

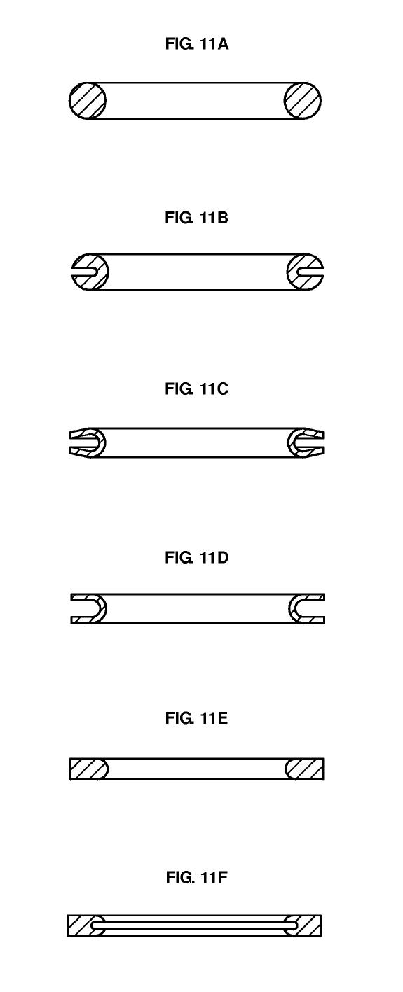

The shock absorbing member T is manufactured with soft synthetic resin which has superior elasticity, vibration and shock absorbing function, O-ring structure which has cylindrical cross section or washer type structure which has rectangular cross section can be used, and in some cases, as cutting groove can be formed in one side to enhance vibration and shock absorbing function, the shock absorbing member T can be carried out in various form. (Reference to FIG. 11)

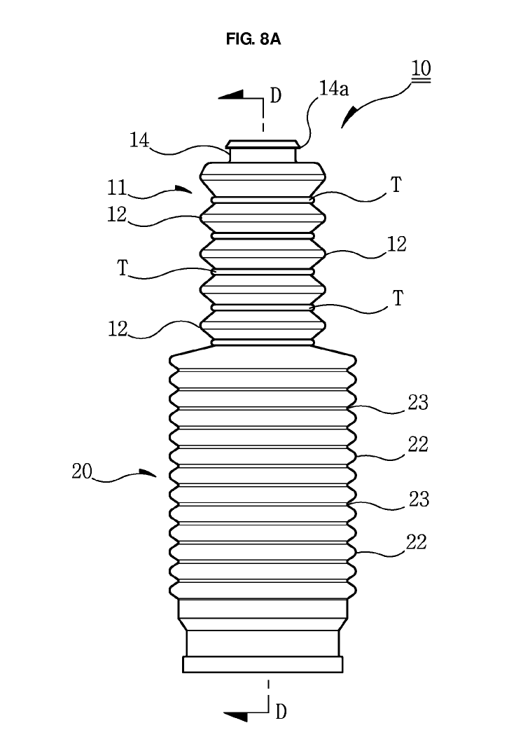

The present invention formed as above is used by installing coil-type spring S between a spring retainer 5 installed in the bottom of a mount bracket 4 and a spring seat 6 installed to maintain regular distance, and installing a cylinder C which passes through the inside of coil-type spring S and mounting on the shock absorber 3, and the bumper stopper 10 and the dust cover 2 are combined in the spring retainer 5 by inserting the locking member 14 of the bumper stopper 10, penetrating the through hole of the dust cover 2 in state of situating the dust cover 2 on the lower side of the spring retainer 5, in through hole prepared in the spring retainer 5, and when the locking member 14 of the bumper stopper 10 is combined to the through hole of the spring retainer 5 then wedge hanging projection 14a prepared in the locking member 14 is hanged in the stepped portion part 5a of the spring retainer 5 and the bumper stopper 10 and the dust cover 2 are stably fixed, and the lot L of the cylinder C is penetrated with the leading hole 17 and the locking hole 15 of the bumper stopper 10 so that the end part of the lot L be fixed on the mount bracket 4. (reference to FIG. 7).

When the cylinder C of the shock absorber 3 ascends due to the impact and vibration generated in the vehicle, the upper part side of the cylinder C bumps against the shock absorbing plate 15 formed in the lower part side of the bumper stopper 10, and the load generated in the impact process of the bumper stopper 10 and the cylinder C is eased since shock absorbing power is given in the bumper stopper 10 by the corrugated projection 12 and corrugated groove 13 formed in the body 11, and with this, the present invention can minimize the impact load of the cylinder C and the bumper stopper 10 transferring to the body of a car.

The present invention eases the impact applied to the bent part R and enhances shock absorbing function of the bumper stopper 10 by absorbing impact with the shock absorbing member T interposed on the bent part R in the process of a body contracting due to the collision between the cylinder C and the bumper stopper 10, also enhances durability of the bumper stopper 10 by minimizing the impact load, and also increases silence by minimizing the noise generated in the process of collision between the shock absorbing member T and the cylinder C.

Also, the noise is not generated from the shock absorber 3 since the bumper stopper 10 does not leave from the spring retainer 5 or moves along with the cylinder lot L even though the movement of the cylinder lot L is generated by the impact applied to the shock absorber 3 since the bumper stopper 10 is fixed to the spring retainer 5.

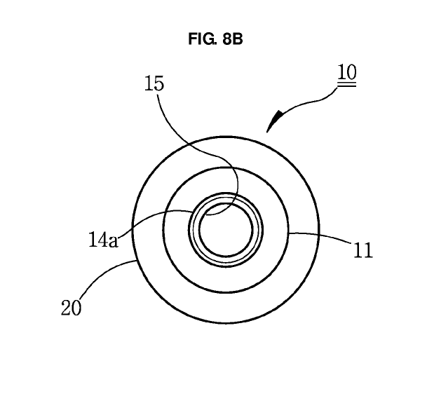

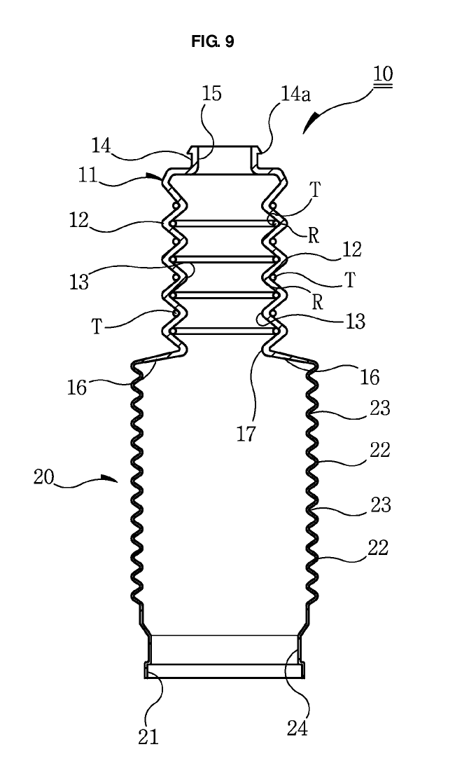

Other embodiment of the bumper stopper 10 presented in the present invention is illustrated in FIG. 8, and a cross-sectional view which cuts the bumper stopper 10 lengthwise is illustrated in FIG. 9. As illustrated, the bumper stopper includes a body into wrinkle pipe by forming a plurality of corrugated projection 12 and corrugated groove 13 which form in equal interval around outer circumferential surface of an elastic synthetic resin body having a thickness of 1.5 mm˜5 mm, installing through hole 15, a locking member 14, and wedge hanging projection 14a on the top of the body 11, and a leading hole 17 which can lead cylinder lot L in the bottom of a body 11.

A body 11, a shock absorbing plate 16, and a dust cover 20 are unified by preparing the shock absorbing plate 16, expanding to the external, in the leading hole 17 installed in the body 11 and preparing a dust cover 20 in the shock absorbing plate 16, and the diameter of the dust cover 20 should have bigger fixed diameter than the body 11.

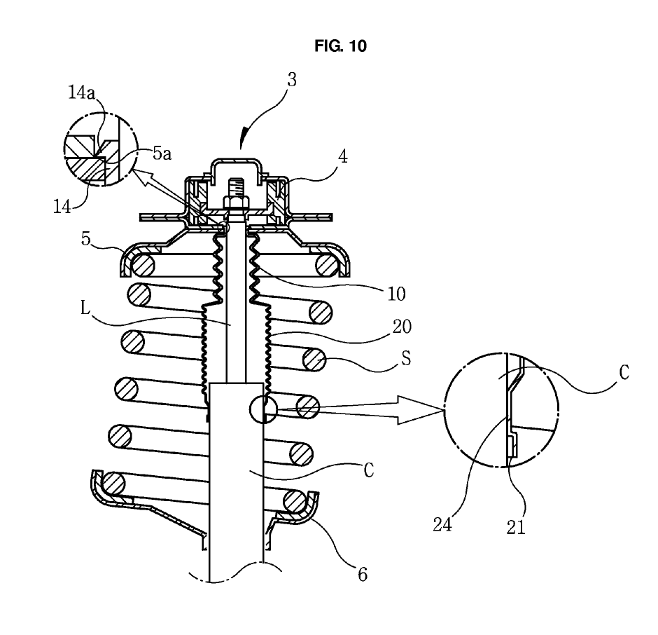

A plurality of corrugated projection 22 and corrugated groove 23 formed continuously at regular interval are formed to form the shock absorbing power by the corrugated projection 22 and corrugated groove 23, and prepare a banding part 24, which has reduced diameter compared to the dust cover 20, in the upper part of a leading opening 21 formed in the bottom of the dust cover 20 and lead the cylinder inside the dust cover 20 in the state of mounting the bumper stopper 10 on the shock absorber 3, and let inner side of the banding part 24 be compressed to the outer circumferential surface of the cylinder C. reference FIG. 10.

Diameters of dust cover 20 and the banding part 24 are elastically planned according to the standard of the cylinder applied to the shock absorber 3, and the diameters of the dust cover 20 and leading opening 21 cannot be specified.

In composing bumper stopper 10 as above, when mounting the bumper stopper 10 on the shock absorber 3 then dust cover 20 which covers the cylinder is also mounted, reference FIG. 10 impurities can be prevented from flowing into the cylinder C since the leading opening 21 is compressed on the surface of the cylinder C, and also dust cover 20 can function expansion and contraction in cylinder C's ascending/descending since the leading opening 21 is compressed to the cylinder C, and with this, the impact load of the cylinder C can be eased since the shock absorbing power generated from the body 11 of the bumper stopper and the power generated form the dust cover 20 are added.

Also, manufacturing cost can be reduced since the number of process and materials can be reduced compared to molding the dust cover 20 and the bumper stopper 10 separately by enabling manufacture with one molding by unifying the bumper stopper 10 and the dust cover 20 and reduce the manufacturing cost, and since mounting bumper stopper 10 on the shock absorber requires also mounting the dust cover 20 covering the cylinder, so the manufacturing process of the shock absorber 3 can be simplified, and also, environmental load can be reduced since entire quantity of the bumper stopper 10 and the dust cover 20 is recyclable.

1. A shock absorber for a bump stopper comprising:
a plurality of corrugated projection 12 and corrugated groove 13, forming hollow wrinkle pipe, which is formed in equal interval around outside of an elastic synthetic resin body 11 having a thickness of 1.5 mm˜5 mm;
a locking member 14 formed to mount the shock absorber on the top of the body 11;
a through hole 15 formed inside the locking member 14;
a leading hole 17 formed to lead cylinder lot L in the central part of a shock absorbing plate 16 forming the lower side of the body 11;
a wedge hanging projection 14a formed in the locking member 14 of the body 11 to be hanged on the stepped portion part 5a of a spring retainer 5; and
an O-ring shock absorbing member T, which is manufactured with soft synthetic resins, to ease the impact applied to a bent part R in contraction of a body 11, in a “<” or “>”-type bent part R which forms in the boundary of inside and outside of the corrugated projection 12 and the corrugated groove 13 of the body 11.

2. A shock absorber for a bump stopper comprising:
a plurality of corrugated projection 12 and corrugated groove 13, forming hollow wrinkle pipe, which form in equal interval around outside of an elastic synthetic resin body having a thickness of 1.5 mm˜5 mm;
a locking member 14, a wedge hanging projection 14a, and a through hole 15 formed to mount a shock absorber on the upper side of a body 11;
a leading hole 17 which can lead cylinder lot L in the bottom of the body 11;
a dust cover 20 arranged in a shock absorbing plate 16 prepared in a leading hole 17 to unify the body 11, the shock absorbing plate 16, and the dust cover 20;
a plurality of corrugated projection 22 and corrugated groove 23 which form in equal interval around outer circumferential surface of the dust cover 20;
a banding part 24 having diameter which is reduced compared to the dust cover 20 in the upper side of the leading opening 21 so that inner side of the bending part 24 can be compressed on the outer circumferential surface of a cylinder C; and
an O-ring shock absorbing member T, which is manufactured with soft synthetic resins, to ease the impact applied to a bent part R in contraction of a body 11, in a “<” or “>”-type bent part R which forms in the boundary of inside and outside of the corrugated projection 12 and the corrugated groove 13 of the body 11, wherein the wedge form hanger projection 14a is placed in the locking member 14 of the body 11 to hang in a stepped portion part 5a of a spring retainer 5.
